(19) United States
(12) Patent Application Publication
(10) Pub. No.: US 2017/0042374 A1
(43) Pub. Date: Feb. 16, 2017

(54) THERMAL FOOD CONTAINER

(71) Applicant: James Young, Jacksonville, FL (US)

(72) Inventor: James Young, Jacksonville, FL (US)

(21) Appl. No.: 14/825,260

(22) Filed: Aug. 13, 2015

(51) Int. Cl. A47J 36/28; F25D 5/00; F24J 1/00; B65D 81/34; A47J 41/00

(52) U.S. Cl. CPC A47J 36/28; B65D 81/3484; A47J 41/0044; F24J 1/00; F25D 5/00

(57) ABSTRACT

A food container (e.g., tray) with a thermal reagent adhesively attached to its outer surfaces reacts with water. The attached reagent undergoes an endothermic (i.e., cooling) or exeothermic (i.e., heating) reaction in the presence of water. A burstable water pouch releases water for the reaction into a lower container (e.g., tray) when the food container is pressed into the lower container, with the pouch therebetween. A removable impervious plastic film may protect the attached reagent while in storage. Multiple reagent layers may be separated by a water-soluble plastic film to provide a prolonged thermal reaction.

### FIELD OF THE INVENTION

This invention relates generally to thermal regulation of food, and, more particularly, to a food tray or other receptacle that undergoes a thermal reaction to chill or heat contained foodstuff.

### BACKGROUND

Many food items must be served at either a chilled or elevated temperature for palatability and to avoid spoliation. As an example, potato salad and other mayonnaise based salads should be chilled when served. Not only does chilling improve the taste, but it also reduces risk of potentially serious illness. Food poisoning is often caused by eating food contaminated by infectious microbes, which thrive in warm humid environments, and therefore flourish in perishable foods unattended in a hot environment. Perishable foods should not be out of refrigeration longer than two hours, or just one hour if the air temperature is above 90° F. As many picnic foods are out of refrigeration longer than an hour, the risk of spoliation poses a serious foot safety challenge.

To avoid spoliation, heretofore perishable foods consumed at picnics may have been placed directly into an insulated cooler from the fridge to make sure it remained cold. Ice or ice packs may have been used to keep the food cold in the cooler and when removed from the cooler. Of course, this approach has always been limited by the availability of ice, which quickly melts and is considerably heavy.

Other heated food items lose palatability when they cool to ambient temperature. For those items, a separate heat source must be provided to heat the food. Portable canned fuel cells containing combustible alcohol (e.g., those sold under the brand Sterno® by Sterno Group LLC) have been widely used to re-heat cooked foods in a tray or chafing dish. While such fuel sources are convenient and portable, they are not without their problems. For example, such fuel sources require an open flame, posing a fire hazard. Fumes produced during combustion can be unpleasant. Additionally, such fuels will evaporate very easily, even when the lid is securely fastened, eventually beyond a point of usage. As a result it is not a good fuel for long-term storage. Such fuels are also relatively expensive.

The invention is directed to overcoming one or more of the problems and solving one or more of the needs as set forth above.

### SUMMARY OF THE INVENTION

To solve one or more of the problems set forth above, in an exemplary implementation of the invention, a food container (e.g., tray) with a thermal reagent adhesively attached to its outer surfaces reacts with water. The attached reagent undergoes an endothermic (i.e., cooling) or exothermic (i.e., heating) reaction in the presence of water. A burstable water pouch releases water for the reaction into a lower container (e.g., tray) when the food container is pressed into the lower container, with the pouch therebetween. Other sources of water may be utilized in lieu of or in addition to the burstable pouch (e.g., a pouch that bursts under pressure or when punctured).

A removable impervious plastic film may protect the attached reagent while in storage. The film preserves the reagent by preventing reaction with ambient moisture while the product is stored.

In another alternative embodiment, multiple reagent layers are separated by a water-soluble plastic film to provide a time release function. In this embodiment, an outer layer undergoes a thermal reaction before the water soluble film dissolves. When the water soluble film dissolves, the inner layer may undergo a thermal reaction.

Another exemplary thermally reactive container assembly for foodstuff, according to principles of the invention includes an upper container nested in a lower container, with a thermal reagent disposed between the containers. The upper container has a first bottom and a first sidewall extending upwardly from the first bottom. The first sidewall and the first bottom defines a first receptacle for containing foodstuff The upper container is thermally conductive. The lower container has a second bottom and a second sidewall extending upwardly from the second bottom. The second sidewall and the second bottom define a second receptacle for nesting engagement of the upper container. The first bottom and at least a portion of the first sidewall are contained (i.e., nested) in the second receptacle. A thermal reagent is disposed between the upper container and the lower container.

A controllable liquid supply in fluid communication with the reagent provides a liquid reagent to react with the thermal reagent. The controllable liquid supply may comprise a bottle, measuring cup or other container from which the liquid (e.g., water or vinegar) is poured into the lower tray. The controllable liquid supply may comprise a sealable fill port through which the liquid may be poured. The controllable liquid supply may comprise a burstable container (e.g., pouch) for the liquid between the lower tray and upper tray that is designed to burst or rupture upon exertion of downward pressure on the bottom of the upper tray.

The thermal reagent may undergo an endothermic reaction with the liquid reagent. The thermal reagent may comprise ammonium nitrate and the liquid reagent may comprise water. The thermal reagent may comprise urea and the liquid reagent may comprise water. The thermal reagent may comprise sodium carbonate and the liquid reagent may comprise acetic acid.

Alternatively, the thermal reagent may undergo an exothermic reaction with water. In such case, the thermal reagent may comprise anhydrous copper(II) sulfate and the liquid reagent may comprise water. The thermal reagent may comprise calcium chloride and the liquid reagent may comprise water. The thermal reagent may comprise iron and a salt catalyst and the liquid reagent may comprise water.

The controllable liquid supply may comprise a burstable container of liquid reagent disposed between the first bottom and the second bottom. Optionally, a spike may extend downwardly from the first bottom towards the burstable container of liquid reagent disposed between the first bottom and the second bottom. In such an embodiment, pressing the first bottom downwardly punctures the burstable container of liquid reagent.

Alternatively, the controllable liquid supply may comprise a sealable port in the first bottom of the upper container through which the liquid reagent may be introduced. The sealable port may be opened to allow the liquid reagent to be introduced, and then sealed or closed to prevent leakage.

An adhesive may be provided to adhesively affixing the thermal reagent to the first bottom.

A plastic film may cover the thermal reagent. The plastic film may comprise a plastic soluble in the liquid reagent. In the case of a liquid reagent comprising water, the plastic film may comprise a plastic soluble in water.

The thermal reagent may comprise a plurality of separate layers of thermal reagent material, with a soluble film separating each of the plurality of separate layers of thermal reagent material. The soluble film is soluble in the liquid reagent. In the case of a liquid reagent comprising water, the plastic film may comprise a plastic soluble in water.

The lower container may be comprised of a thermally insulating material such as a closed cell foam.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side view of a prior art food tray; and

FIG. 2 is a top perspective view of a prior art food tray; and

FIG. 3 is a side view of an exemplary tray with a thermal coating along the bottom and sides in accordance with principles of the invention; and

FIG. 4 is a top perspective view of an exemplary tray with a thermal coating along the bottom and sides in accordance with principles of the invention; and

FIG. 5 is a side view of an exemplary tray with a thermal coating along the bottom and sides above a mating bottom tray which will contain water as a reagent in accordance with principles of the invention; and

FIG. 6 is a to perspective view of an exemplary tray with a thermal coating along the bottom and sides above a mating bottom tray which contains poured water and/or a burstable film of water as a reagent in accordance with principles of the invention; and

FIG. 7 is a side view of an exemplary tray with a thermal coating along the bottom and sides nested in and mating with a bottom tray which will contain water as a reagent in accordance with principles of the invention; and

FIG. 8 is a top perspective view of an exemplary tray with a thermal coating along the bottom and sides nested in and mating with a bottom tray, which contains poured water and/or a burstable film of water as a reagent in accordance with principles of the invention; and

FIG. 9 is a schematic of an exemplary thermal coating with a protective outer film in accordance with principles of the invention; and

FIG. 10 is a schematic of an exemplary multilayer thermal coating with an intermediate water soluble film and a protective outer film in accordance with principles of the invention; and

FIG. 11 is a side view of an exemplary tray with a thermal coating along the bottom and sides slightly above a mating bottom closed cell foam insulating tray which will contain water (e.g., a burstable pouch of water) as a reagent in accordance with principles of the invention; and

FIG. 12 is a perspective view of an exemplary tray with a thermal coating along the bottom and sides slightly above a mating bottom closed cell foam insulating tray which will contain water (e.g., a burstable pouch of water) as a reagent in accordance with principles of the invention; and

FIG. 13 is a cross section view (Section A-A from FIG. 12) of an exemplary tray with a thermal coating along the bottom and sides slightly above a mating bottom closed cell foam insulating tray which will contain water (e.g., a burstable pouch of water) as a reagent in accordance with principles of the invention; and

FIG. 14 is a side view of an exemplary tray with a thermal coating along the bottom and sides slightly mated with a bottom closed cell foam insulating tray which will contain water (e.g., a burstable pouch of water) as a reagent in accordance with principles of the invention; and

FIG. 15 is a perspective view of an exemplary tray with a thermal coating along the bottom and sides mated with a bottom closed cell foam insulating tray which will contain water (e.g., a burstable pouch of water) as a reagent in accordance with principles of the invention; and

FIG. 16 provides a perspective view of a portion of a bottom of the upper container (i.e., upper tray) with an exemplary fill port, which, when openend, a liquid reagent (e.g., water) may be introduced (e.g., poured) to react with the thermal reagent between the upper and lower containers; and

FIG. 17 provides a perspective view of a portion of a bottom of the upper container (i.e., upper tray) with an exemplary fill port with a threaded plug removed from a threaded collar, through which a liquid reagent (e.g., water) may be introduced (e.g., poured) to react with the thermal reagent between the upper and lower containers.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

As used herein, exothermic and endothermic reactions are “thermal reactions.” An exothermic reaction releases energy in the form of heat while an endothermic reaction absorbs energy in the form of heat. The effect on surroundings differs. The exothermic reaction heats the surroundings, while the endothermic reaction cools the surroundings. Nonlimiting examples of exothermic reactions include water and an anhydrous salt (e.g., anhydrous copper(II) sulfate) or calcium chloride, or oxidation of iron (e.g., iron reacting with water and a salt catalyst such as NaCl). Nonlimiting examples of endothermic reactions include water and ammonium nitrate, water and urea, and acetic (ethanoic) acid and sodium carbonate. For simplicity, reactions that utilize water as a reagent are preferred for use with a thermal food tray according to principles of the invention.

A food tray according to principles of the invention holds foodstuff, which may comprise foods and/or beverages. While rectangular trays are conceptually illustrated in the drawings, those skilled in the art will appreciate that containers of other shapes, proportions and sizes may be utilized in accordance with the principles of the invention.

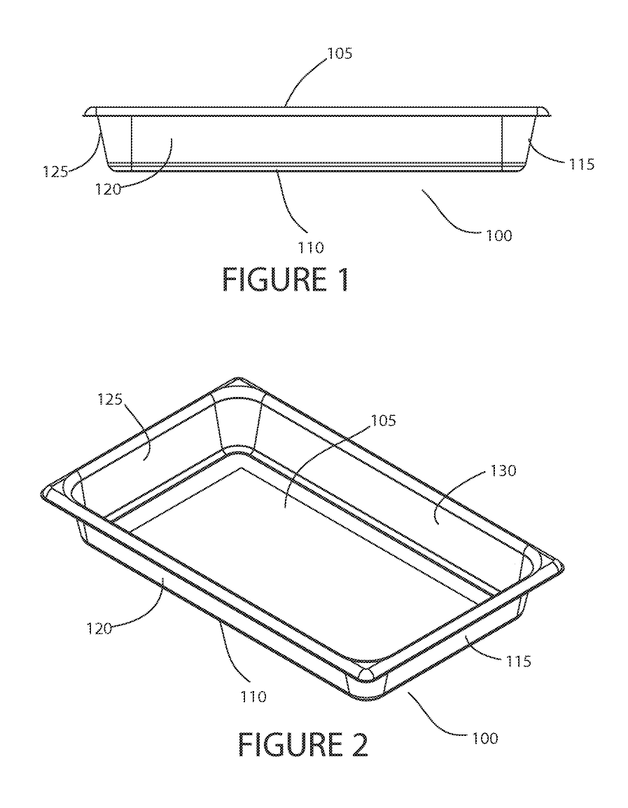

Referring now to FIGS. 1 and 2, a conventional food tray is illustrated. While the invention is not limited to use with any particular shaped tray or even to a food tray, such a tray is useful for illustrating the principles of the invention and is used herein as a nonlimiting example of a type or receptacle to which the principles of the invention may be applied. The exemplary tray 100 includes an open top 105, a base 110, and four sides 115, 120, 125 and 130. The familiar structure may be used to contain a wide variety of food products, either hot or cold. The tray may be comprised of any food compatible material. In a preferred implementation, the tray is comprised of a highly conductive material such as a thin metal foil, e.g., aluminum foil. Additionally, in a preferred implementation, the tray is disposable.

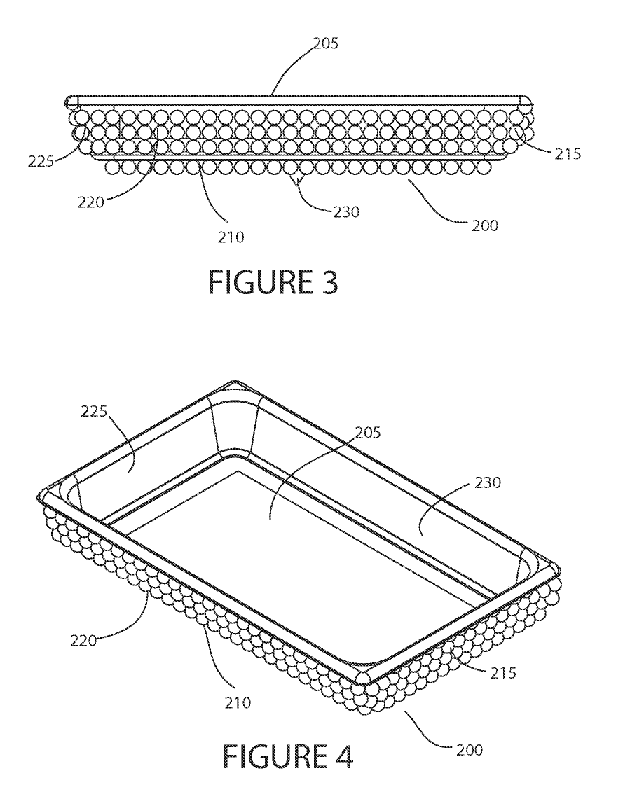

FIGS. 3 and 4 illustrate an exemplary tray 200 with an open top 205 and a thermal coating along the bottom (base) 210 and all sides 215, 220, 225, 230 in accordance with principles of the invention. The outer surfaces of the base 110 and sides 115, 120, 125, 130 of a tray 100, such as the conventional tray 100 shown in FIGS. 1 and 2, are coated with a thin layer of adhesive, such as a food-safe adhesive. The adhesive coated outer surfaces are then coated with a solid particle thermal reagent. The adhesive is allowed to cure. The thickness of the adhesive layer is less than the average diameter of the adhesively bonded solid particles. Thus, the particles are not fully encapsulated by the adhesive. Rather, at least a portion of the particles remains exposed through the adhesive.

Advantageously, by adhering the thermal coating to the bottom (base) 210 and all sides 215, 220, 225, 230, the invention provides more even cooling or heating than could otherwise be achieved by placing a conventional cold or hot pack below the tray 200. Such even cooling and heating provides more efficient heat transfer and better food.

A nonlimiting example of a suitable particle is ammonium nitrate (NH₄NO₃) prills. When ammonium nitrate dissolves in water, it breaks down into its ions: ammonium and nitrate. The solubility of ammonium nitrate in water varies with temperature from about 118 g of ammonium nitrate in 100 ml at 0° C.; 150 g of ammonium nitrate in 100 ml of water at 20° C.; 297 g of ammonium nitrate in 100 ml of water at 40° C.; and 410 g of ammonium nitrate in 100 ml of water at 60° C. Thus, the amount of particulate reagent relative to the volume of water may vary according to ambient temperature.

Also shown in FIG. 3 is an optional spike 230. The spike 230 may be a bendable spike with a pointed tip for puncturing a pouch of water (described below). After puncturing the pouch, impact with the underlying base tray (described below) causes the spike to 230 fold relatively flat against the base 210 of the tray 200.

The reagents include a solid particle that reacts with water in a thermal reaction. The solid is present as particles of from about 10 to 1000 U.S. mesh; though the invention is not limited by particle size. The particles employed may be approximately all the same size, that is, within about 20% of the average diameter, or mixtures of particles may be employed, ranging from particles at either end of the range with the range of particles differing by more than 200% in diameter. By varying the size distribution of the particles, one may also vary the temperature profile, although the size of the particle will be a substantially less significant factor than other factors. The particle may be of any material which can be used to react with water to result in an endothermic reaction to provide a desired temperature reduction, or an exothermic reaction to provide a desired temperature increase.

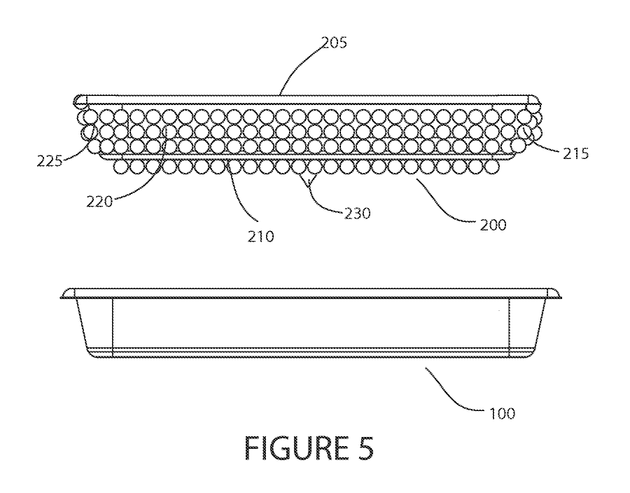

FIG. 5 illustrates the exemplary tray 200 with the open top 205 and a thermal coating along the bottom (base) 210 and all sides 215, 220, 225, 230, being placed in another tray 100. The trays are configured for nesting engagement, with the upper tray 200 fitting substantially in the compartment of the lower tray 100. The lower tray 100 will also contain water that will react with the reagent adhered to the sides 215, 220, 225, 230 of the upper tray 200. This reaction is a thermal reaction. Depending upon the particulate reagent, it may be either an exothermic or endothermic reaction.

The upper tray 200 is preferably thermally conductive. Thus, heat transfer between the reagent reacting with water and the contents of the upper tray 200 is not substantially impeded. Metal, steel, aluminum, foil, and tin trays are suitable.

Optionally, the outer surface of the base and sides of the lower tray 100 may be insulated to improve efficiency of heat transfer between the reacting reagents and the foodstuff contained in the upper tray 200. Alternatively, the lower tray may be substantially comprised of a thermally insulating material. Insulation reduces heat loss from an exothermic reaction, and reduces conduction of heat from ambient environment in an endothermic reaction.

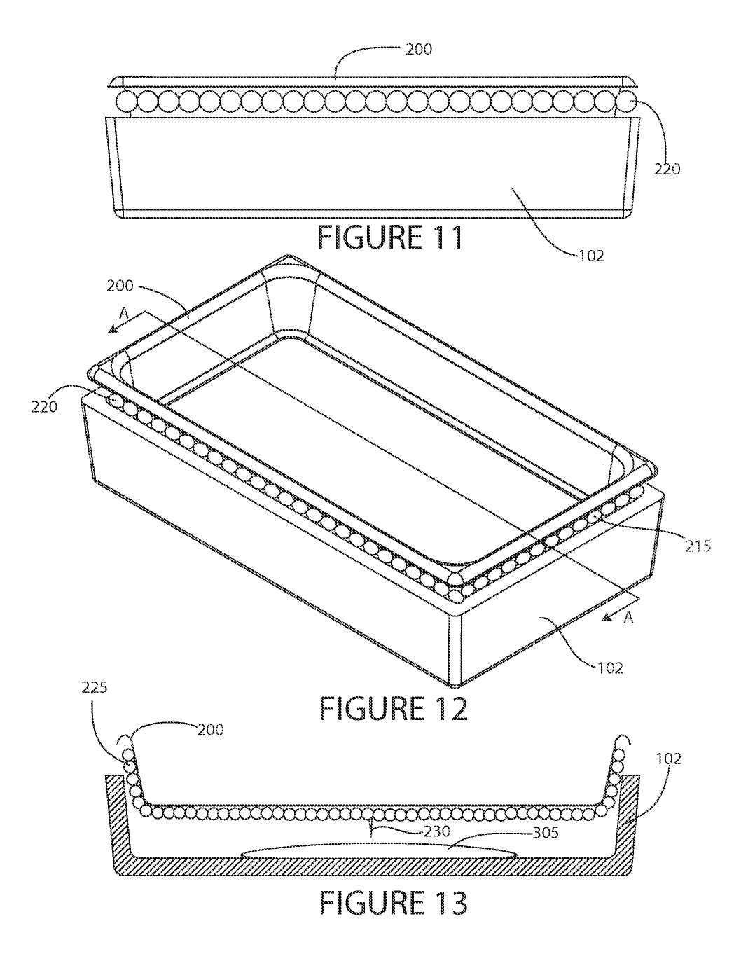

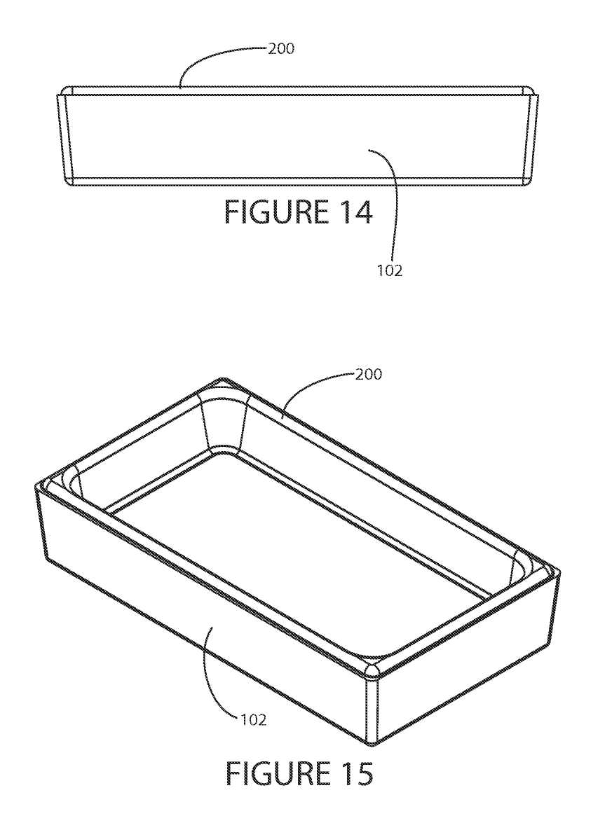

By way of example and not limitation, with reference to the embodiments of FIGS. 11 through 15, the lower tray 102 may comprise a substantially thermally nonconductive material, such as closed-cell extruded or expanded polystyrene foam, or other thermal insulating polymeric material. In such embodiment, the lower tray 102 is not only configured (i.e., sized and shaped) to receive the cooled tray 200 and to retain water, but also to limit heat transfer to and from the ambient environment surrounding the exterior of the lower tray 102. The walls of such a lower tray 102 may have a thickness of about 0.125 inches or greater. As increased thickness provides greater thermal insulation, a thickness of at least 0.25 inches, and more preferably (but without limitation) at least 0.5 inches is used. FIGS. 11 through 13 show an upper tray 200 being inserted into such a lower tray 102. FIGS. 14 and 15 show the upper tray 200 inserted into the lower tray 102.

Additionally, an insulating or transparent cover may be provided for placement over the upper tray 200 in the lower tray 102. In the case of an insulating cover, the cover may be comprised of the same insulating closed-cell foam material as the lower tray. In either case the cover may provide space between the top of the upper tray 200 and the top of the cover, to allow covering of food piled up in the upper tray 200.

When fully inserted, a spike 230 extending downwardly from the upper tray 200 may puncture the burstable pouch 305 to release water in the space between the nested trays 102, 200, which is the same space occupied by the reagent 210-225 coating the outer sides and bottom of the upper tray 200. Thus, a user may press the upper tray 200 into the lower tray 102 to release water to initiate an exothermic (heating) or endothermic (cooling) reaction with the reagent. The thermally insulating lower tray 102 contains the released water as it reacts with the reagent, while preventing or reducing heat transfer to and from the ambient environment through the lower tray 102. Thus, cooling and heating are directed to the upper tray 200 and its foodstuff (or beverage) contents, rather than to the ambient environment.

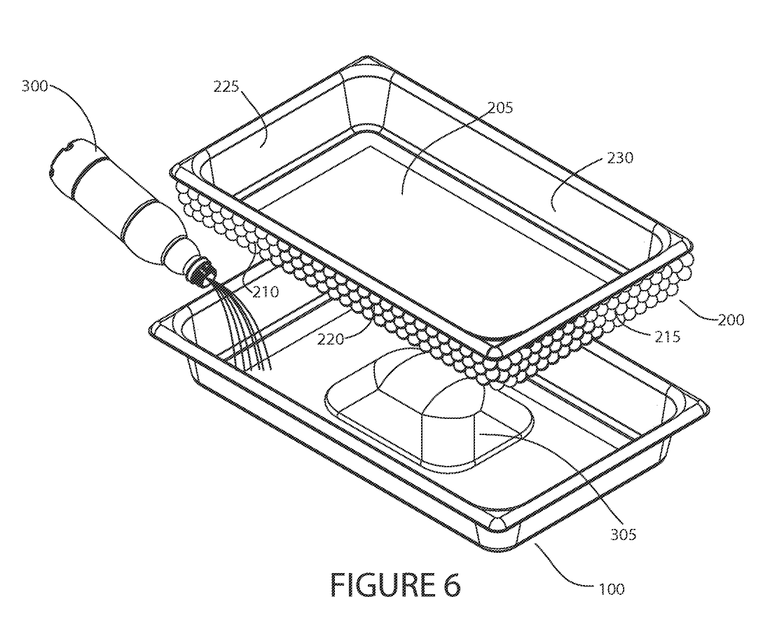

FIG. 6 again illustrates the exemplary tray 200 with the open top 205 and a thermal coating along the bottom (base) 210 and all sides 215, 220, 225, 230, being placed in another tray 100. Also shown in FIG. 6 are water being poured from a bottle 300 into the bottom tray 100 and a burstable pouch 305 of water within the bottom tray. As the reaction requires water, a water source must be provided. In one embodiment, a burstable pouch 305 of water is provided. The pouch may be comprised of a water-impermeable plastic film. When pressure is applied, such as when the upper tray 200 is pressed down upon the lower tray 100 with the pouch in between the lower 100 and upper 200 trays, the pouch will burst releasing the water. If a spike 230 is provided on the bottom of the upper tray 100, then the spike may puncture the pouch 305 while yielding to the lower tray 100 so as to not puncture it. If a pouch 305 is not used, then water may be supplied from any source such as a water bottle 300.

The bottle 300 and pouch 305 are nonlimiting examples of a controllable liquid supply in fluid communication with the reagent to provide a liquid reagent to react with the thermal reagent. The controllable liquid supply may comprise a bottle, measuring cup or other container from which the liquid (e.g., water or vinegar) is poured into the lower tray. Alternatively, the controllable liquid supply may comprise a sealable fill port through which the liquid may be poured, as describe more fully below. As another alternative, the controllable liquid supply may comprise a burstable container (e.g., pouch) for the liquid between the lower tray and upper tray that is designed to burst or rupture upon exertion of downward pressure on the bottom of the upper tray.

In one embodiment, cooled inner tray 200 is contained in and sealed against outer tray 100, with the burstable pouch 305 of water and solid particle reagent between the outer tray 100 and inner tray 200. Application of pressure to the base of the inner tray causes the burstable pouch 305 of water to burst, causing contained water to escape and react with the solid particle reagent.

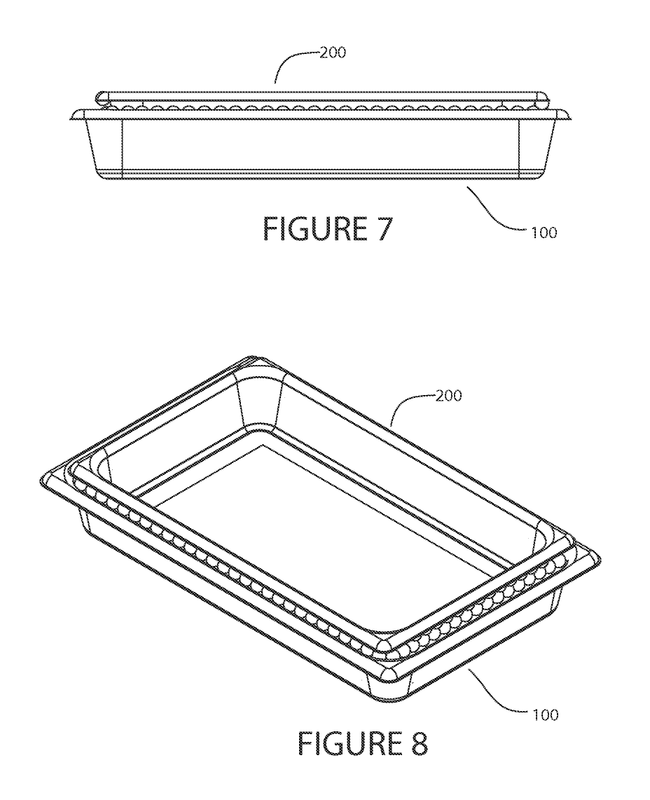

FIGS. 7 and 8 illustrate the upper tray 200 set in the lower tray. With water contained by the lower tray 100, the thermal reaction proceeds, heating or cooling the upper tray 200 and foodstuff contained therein.

In a preferred embodiment, sufficient water is added to dissolve the entire exposed particulate reagent. Knowing the mass of particulate reagent and using solubility data for average outdoor temperature conditions between 15° C. and 30° C., one can extrapolate an appropriate volume of water to add for complete or nearly complete dissolution. Excess water is preferred. Thus, for example, 120% of the calculated volume may be provided in a pouch or recommended for addition from a bottle or other source.

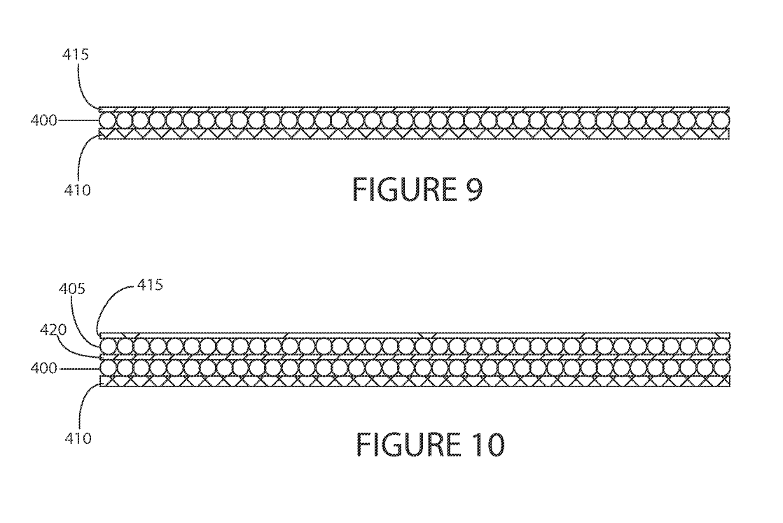

To protect the particulate reagent while in storage a removable plastic film may be adhered to or otherwise applied (e.g. shrink wrapped) over the coated surfaces. The plastic film is conceptually illustrated as layer 415 in FIGS. 9 and 10. The intermediate layer 400 represents the particulate reagent. The lower layer 410 represents the adhesive 410 bonding the particulate reagent to the surfaces of the tray 200. In one embodiment, the film comprises a water soluble plastic.

To prolong cooling or heating ability, several layers (e.g., more than one layer) 400, 405 of particulate reactant may be provided, as shown in FIG. 10. Layers 400, 405 may be separated by a water soluble film such as 420. The film is preferably made of a film material which is soluble or dispersible in water, and has a water-solubility of at least 50%, preferably at least 75% or even at least 95%. Preferred film materials are polymeric materials, preferably polymers which are formed into a film or sheet. The film material can, for example, be obtained by casting, blow-molding, extrusion or blown extrusion of the polymeric material, as known in the art. Preferred polymers, copolymers or derivatives thereof suitable for use as film material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the film material, for example a PVA polymer, is at least 60%. Mixtures of polymers can also be used as the film material. This can be beneficial to control the mechanical and/or dissolution properties of the compartments or film, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Most preferred film materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray. These are nonlimiting examples.

In multilayer embodiments, sufficient water should be added to dissolve all layers of the particulate reagent and the soluble plastic film layers. The volume of water may be provided to the lower tray at the outset or added in increments over time.

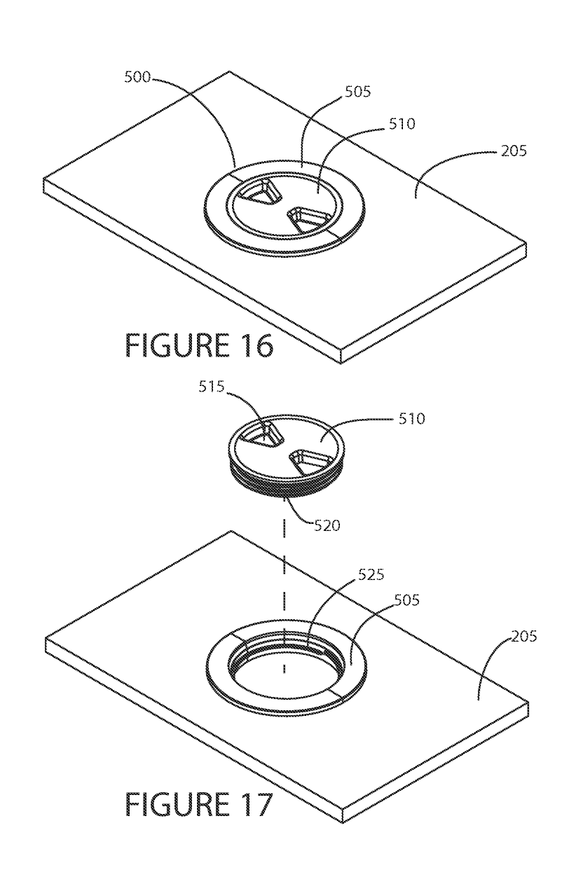

FIGS. 16 and 17 provide a perspective views of a portion of a bottom 205 of the upper container (i.e., upper tray 200) with an exemplary fill port 500, which, when opened, a liquid reagent (e.g., water) may be introduced (e.g., poured) to react with the thermal reagent between the upper and lower containers. The exemplary port 500 is opened by removing (e.g., unthreading) the plug 510 from the collar 505. The opened collar 505 reveals an opening through the bottom 205 of the upper container 200. The exemplary plug 510 includes threads 520 that threadedly engage threads 525 of the collar. Optionally, the plug 510 includes one or more protrusions or depressions 515 to facilitate turning for threading and un-threading. Other fill ports may be utilized in lieu of the exemplary fill port illustrated in FIGS. 16 and 17. Such other fill ports may comprise a plug that engages a collar using a snap fit or frictional connection. The plug may be tethered or hinged to the collar. Alternatively, the fill port may comprising a gasketed door that closes tightly over a door frame using a snap fit connection, friction, or mechanical closure such as a latch.

The drawings illustrate generally rectangular trays as containers for purposes of illustrating an exemplary embodiment. The invention is not limited to a particular shape or size container. Cylindrical, hemispherical and other shaped containers of various sizes may be utilized within the scope of the invention. By way of example and not limitation, a cylindrical drink container with an open top and a cylindrical bottom container with an open top may be utilized to chill or heat the contents of the cylindrical drink container, in accordance with the principles of the invention. In such an embodiment, the cylindrical drink container replaces upper tray 200, and the cylindrical bottom container replaces lower tray 100 or 102.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A thermally reactive container assembly for foodstuff comprising:
an upper container having a first bottom and a first sidewall extending upwardly from the first bottom, the first sidewall and the first bottom defining a first receptacle for containing foodstuff, the upper container being thermally conductive;
a lower container having a second bottom and a second sidewall extending upwardly from the second bottom, the second sidewall and the second bottom defining a second receptacle for nesting engagement of the upper container, with the first bottom and at least a portion of the first sidewall being contained in the second receptacle;
a thermal reagent disposed between the upper container and the lower container; and
a controllable liquid supply in fluid communication with the reagent, the controllable liquid supply providing a liquid reagent to react with the thermal reagent.

2. The thermally reactive container assembly for foodstuff according to claim 1, the thermal reagent undergoing an endothermic reaction with the liquid reagent.

3. The thermally reactive container assembly for foodstuff according to claim 2, the thermal reagent comprising ammonium nitrate and the liquid reagent comprising water.

4. The thermally reactive container assembly for foodstuff according to claim 2, the thermal reagent comprising urea and the liquid reagent comprising water.

5. The thermally reactive container assembly for foodstuff according to claim 2, the thermal reagent comprising sodium carbonate and the liquid reagent comprising acetic acid.

6. The thermally reactive container assembly for foodstuff according to claim 1, the thermal reagent undergoing an exothermic reaction with water.

7. The thermally reactive container assembly for foodstuff according to claim 5, the thermal reagent comprising anhydrous copper(II) sulfate and the liquid reagent comprising water.

8. The thermally reactive container assembly for foodstuff according to claim 5, the thermal reagent comprising calcium chloride and the liquid reagent comprising water.

9. The thermally reactive container assembly for foodstuff according to claim 5, the thermal reagent comprising iron and a salt catalyst and the liquid reagent comprising water.

10. The thermally reactive container assembly for foodstuff according to claim 1, the controllable liquid supply comprising a burstable container of liquid reagent disposed between the first bottom and the second bottom.

11. The thermally reactive container assembly for foodstuff according to claim 10, further comprising a spike extending downwardly from the first bottom towards the burstable container of liquid reagent disposed between the first bottom and the second bottom.

12. The thermally reactive container assembly for foodstuff according to claim 1, the controllable liquid supply comprising a sealable port in the first bottom of the upper container through which the liquid reagent may be introduced.

13. The thermally reactive container assembly for foodstuff according to claim 1, further comprising an adhesive, the adhesive adhesively affixing the thermal reagent to the first bottom.

14. The thermally reactive container assembly for foodstuff according to claim 13, further comprising a plastic film, the plastic film covering the thermal reagent.

15. The thermally reactive container assembly for foodstuff according to claim 14, the plastic film comprising a plastic soluble in the liquid reagent.

16. The thermally reactive container assembly for foodstuff according to claim 14, the plastic film comprising a plastic soluble in water and the liquid reagent comprising water.

17. The thermally reactive container assembly for foodstuff according to claim 1, the thermal reagent comprising a plurality of separate layers of thermal reagent material, with a soluble film separating each of the plurality of separate layers of thermal reagent material, the soluble film being soluble in the liquid reagent.

18. The thermally reactive container assembly for foodstuff according to claim 1, the thermal reagent comprising a plurality of separate layers of thermal reagent material, with a soluble film separating each of the plurality of separate layers of thermal reagent material, the soluble film being soluble in water and the liquid reagent comprising water.

19. The thermally reactive container assembly for foodstuff according to claim 1, the lower container comprising a thermally insulating material.

20. The thermally reactive container assembly for foodstuff according to claim 19, the lower container comprising a closed cell foam.
